(19) United States
(12) Patent Application Publication
(10) Pub. No.: US 2021/0304586 A1
(43) Pub. Date: Sep. 30, 2021

(54) Security System And Method Thereof

(71) Applicants: Zhiwu Deng, Calgary (CA); Hua Deng, Calgary (CA)

(72) Inventors: Zhiwu Deng, Calgary (CA); Hua Deng, Calgary (CA)

(21) Appl. No.: 17/207,730

(22) Filed: Mar. 21, 2021

(30) Foreign Application Priority Data
Mar. 24, 2020 (CA) 3076943

(51) Int. Cl. G08B 27/00; G08B 7/06

(52) U.S. Cl. CPC G08B 27/003; G08B 27/005; G08B 7/064

(57) ABSTRACT

A security system for detecting an emergency event in a building. The system has one or more sensors deployed in the building for monitoring the building; one or more first action devices deployed in the building for responding to the emergency event; one or more second action devices deployed outside the building for broadcasting an alert of the emergency event to public near the building; and a control circuitry connected to the one or more sensors, the one or more first action devices, and the one or more second action devices for collecting data from the one or more sensors, detecting the emergency event, and responding to the emergency event with broadcasting the alert of the emergency event to the public near the building.

### FIELD OF THE DISCLOSURE

The present disclosure relates generally to a security system and method thereof, and in particular to a security system and method using sound, light, and smoke for public alerts.

### BACKGROUND

Security systems are known. For example, home security systems have been widely deployed in residential homes. Such a security system generally comprises a plurality of sensors such as surveillance cameras, motion sensors, door/window status sensors, smart locks, smoke detectors, and the like, deployed in various locations of a home and connected to a control panel using wired or wireless means. The security system may also comprise one or more speakers deployed in the home (e.g., integrated with the control panel) for announcing the occurrence of a security or emergency event. The security system may also be connected to a response center (e.g., a security company) for management and for quick response.

One of the disadvantages of such security systems is that the detection and responses to a security or emergency event is generally conducted in a “hidden mode” without prompt public notification. Consequently, the security/emergency events are generally isolated and, without prompt help from the public, responses to such security/emergency events are usually delayed, thereby causing damages that may otherwise be avoided.

Therefore, there is a need for an improved security system for engaging at least the public near the location of a security/emergency event.

### SUMMARY

According to one aspect of this disclosure, there is provided a security system for detecting an emergency event in a building. The system comprises: one or more sensors deployed in the building for monitoring the building; one or more first action devices deployed in the building for responding to the emergency event; one or more second action devices deployed outside the building for broadcasting an alert of the emergency event to public near the building; and a control circuitry connected to the one or more sensors, the one or more first action devices, and the one or more second action devices for collecting data from the one or more sensors, detecting the emergency event, and responding to the emergency event with broadcasting the alert of the emergency event to the public near the building.

In some embodiments, the one or more second action devices comprise one or more smoke generators for generating colored smoke during the emergency event.

In some embodiments, the building comprises a plurality of entrances; and each of the one or more smoke generators is deployed at a location outside the building corresponding to a respective one of the plurality of entrances.

In some embodiments, the one or more smoke generators are deployed on a roof of the building.

In some embodiments, the one or more second action devices comprise at least one of: one or more lights for flashing with a predefined pattern during the emergency event; and one or more audible devices for broadcasting an audible alert during the emergency event, said audible alert comprising information of a location of the emergency event.

In some embodiments, the security system further comprises one or more server computers connected to the control circuitry via a network.

In some embodiments, the security system further comprises one or more client computing devices connected to the control circuitry via a network.

In some embodiments, the security system further comprises one or more identification-mark spray devices connected to the control circuitry for spraying an identification-mark.

In some embodiments, the identification-mark comprise a detectable material attachable to an intruder.

In some embodiments, the identification-mark comprise a colored ink and/or a colored powder attachable to an intruder.

In some embodiments, the identification-mark comprise a magnetic or ferromagnetic ink or powder attachable to an intruder.

In some embodiments, the one or more identification-mark spray devices at one or more entrances of the building aiming towards a predefined body section of the intruder.

In some embodiments, the security system further comprises one or more net guns.

In some embodiments, the building comprises a plurality of building units; and the security system further comprises a display for showing a list of the building units and/or floors thereof and, during the emergency event, for showing an indication of one of the building units and/or one of the floors where the emergency event is occurring.

In some embodiments, the security system further comprises a connection to one or more response teams.

According to one aspect of this disclosure, there is provided one or more non-transitory computer-readable storage devices comprising computer-executable instructions for detecting an emergency event in a building. The instructions, when executed, cause a processing structure to perform actions comprising: receiving data from a plurality of sensors deployed in the building; detecting the emergency event; activating one or more first action devices deployed in the building for responding to the emergency event; and broadcasting the emergency event to public near the building.

In some embodiments, said broadcasting the emergency event to the public near the building comprises broadcasting the emergency event to the public near the building via one or more smoke generators deployed outside the building.

In some embodiments, said broadcasting the emergency event to the public near the building comprises broadcasting the emergency event to the public near the building via one or more smoke generators deployed on a roof of the building.

In some embodiments, said broadcasting the emergency event to the public near the building comprises broadcasting the emergency event to the public near the building via one or more lights deployed outside the building and flashing with a predefined pattern; and broadcasting the emergency event to the public near the building by broadcasting an audible alert via one or more audible devices deployed outside the building, said audible alert comprising information of a location of the emergency event.

In some embodiments, the instructions, when executed, cause the processing structure to perform further actions comprising sending information of the emergency event to a server computer via a network.

In some embodiments, the instructions, when executed, cause the processing structure to perform further actions comprising sending information of the emergency event to one or more client computing devices via the network.

In some embodiments, the instructions, when executed, cause the processing structure to perform further actions comprising detecting an intruder.

In some embodiments, the instructions, when executed, cause the processing structure to perform further actions comprising spraying an identification-mark about the intruder.

In some embodiments, the instructions, when executed, cause the processing structure to perform further actions comprising spraying a colored ink and/or a colored powder about the intruder.

In some embodiments, the instructions, when executed, cause the processing structure to perform further actions comprising spraying a magnetic or ferromagnetic ink or powder about the intruder.

In some embodiments, the instructions, when executed, cause the processing structure to perform further actions comprising ejecting a net towards the intruder.

In some embodiments, the building comprises a plurality of building units; and the instructions, when executed, cause the processing structure to perform further actions comprising: displaying a list of the building units and/or floors thereof; and displaying, during the emergency event, an indication of one of the building units and/or one of the floors where the emergency event is occurring.

In some embodiments, the building comprises a plurality of building units; and the instructions, when executed, cause the processing structure to perform further actions comprising reporting the emergency event to one or more response teams.

### BRIEF DESCRIPTION OF THE DRAWINGS

FIG. 1A is a schematic diagram of a security system, according to some embodiments of the present disclosure;

FIG. 1B is a schematic plan view of an example of the security system shown in FIG. 1A;

FIG. 2 is a schematic diagram showing a simplified hardware structure of control circuitry of the security system shown in FIG. 1A;

FIG. 3 is a schematic diagram showing a simplified hardware structure of a computing device of the security system shown in FIG. 1A;

FIG. 4 a schematic diagram showing a simplified software architecture of a computing device of the security system shown in FIG. 1A;

FIG. 5 is a flowchart showing a process executed by a control circuitry of the security system shown in FIG. 1A for monitoring and responding to emergency events;

FIG. 6 is a schematic perspective view of a multiple-unit building with deployment of the security system shown in FIG. 1A;

FIG. 7 shows an example of an information display showing a list of building units of the multiple-unit building shown in FIG. 6 and/or the floors thereon;

FIG. 8 is a schematic diagram of an example of the security system shown in FIG. 1A;

FIG. 9 is a schematic diagram of another example of the security system shown in FIG. 1A; and

FIG. 10 is a schematic diagram of a security system, according to some alternative embodiments of the present disclosure.

### DETAILED DESCRIPTION

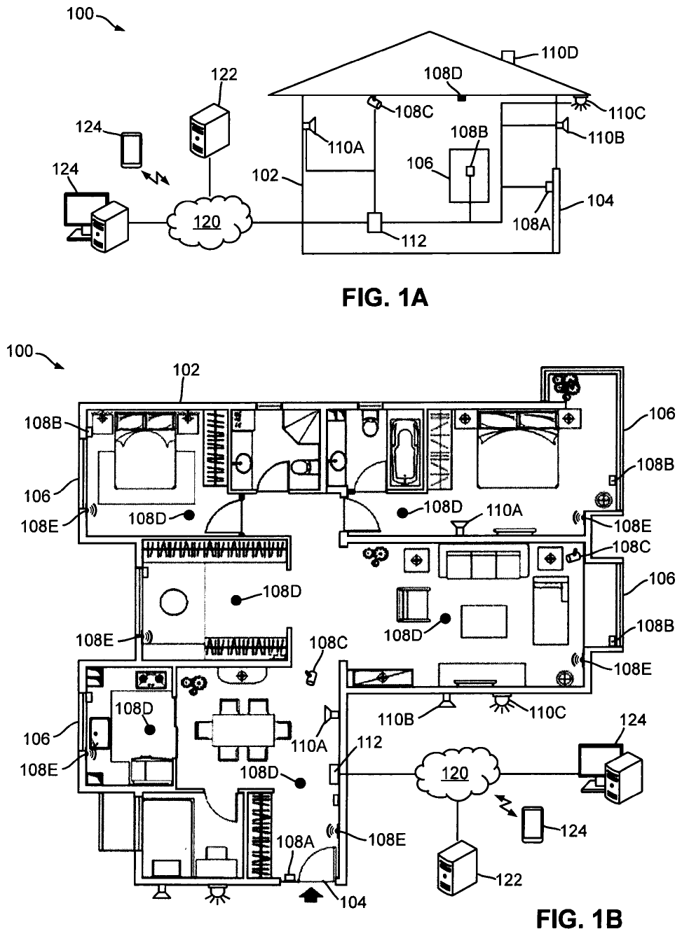

Turning to FIGS. 1A and 1B, a security system is shown and is generally identified using reference numeral 100. In these embodiments, the security system 100 is installed in a residential or commercial building 102 such as a residential detached house, a residential semi-detached house (also called a “duplex”), a residential townhouse, a retail store, a business building, a warehouse, or the like, which may be considered as a single unit (e.g., occupied by a single family, a single business unit, or the like). The building 102 generally comprises a plurality of accesses or entrances such as one or more doors 104 and windows 106.

The security system 100 comprises a plurality of sensors 108 and a plurality of action devices 110 deployed inside and/or outside the building 102. The sensors 108 and action devices 110 are connected to a control circuitry 112 via suitable wired or wireless communication technologies such as WI-FI® (WI-FI is a registered trademark of Wi-Fi Alliance, Austin, Tex., USA), BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G, 4G, 5G, and/or 6G wireless mobile telecommunications technologies, Ethernet, parallel cables (e.g., parallel cables with DB-25 connectors), serial cables (e.g., RS232 cables), USB connections, optical connections, and/or the like.

In these embodiments, the control circuitry 112 is also connected to a network 120 such as the Internet, a local area network (LAN), a wide area network (WAN), a metropolitan area network (MAN), and/or the like, via suitable wired and wireless communication technologies, for connecting to one or more server computers 122. The system 100 may also comprise one or more personal computing devices 124 (also called “client computing devices”) connecting to the network 120 for managing the system 100 and the devices therein.

In these embodiments, the plurality of sensors 108 may comprise one or more door/window status sensors 108A for detecting the opening and closing of respective doors 104 and/or windows 106, one or more glass-break sensors 108B for detecting breaking of glass of respective windows 106, one or more imaging devices 108C such as surveillance cameras, one or more smoke detectors 108D, one or more motion sensors 108E (e.g., motion sensors using passive infrared (PIR), microwave, optical, and/or ultrasonic technologies, tomographic motion detectors, and/or the like), one or more proximity sensors (not shown) using suitable technologies (e.g., capacitive, inductive, magnetic, optical, ultrasonic, radar, sonar, Doppler effect, Hall effect technologies, and/or the like), smart locks (not shown), emergency triggers (e.g., emergency buttons, fire-alarm switches, and/or the like, not shown), and/or other suitable sensors.

The sensors 108 may be installed at suitable locations inside and/or outside the building 102. For example, a door/window status sensor 108A may be installed on each door and window; a glass-break sensor 108B may be installed on or adjacent each window; surveillance cameras 108C may be installed in hallway, living room, kitchen, bedroom (with sufficient privacy protection), garage, exterior of the building 102 (e.g., about the entrances, preferably at locations of sufficient heights); smoke detectors 108D may be installed in each room and/or hallway; motion sensors 108E may be installed in hallway, entrance, locations adjacent doors and windows, and other suitable locations; proximity sensors may be installed adjacent doors and windows; smart locks may be installed on entrance doors; and emergency triggers may be installed in hallway, living room, bedroom, or other rooms at convenient locations to allow the user to turn on the triggers when security and/or emergency events (also denoted “emergency events” for ease of description) occur. Herein, an emergency event may be a security event such as an intrusion event when the system is configured to an “armed” state and one or more sensors detect an intruder, an emergency event such as a fire-hazard event when a smoke detector 108D detects smoke, or the like.

In these embodiments, the plurality of action devices 110 may comprise one or more audible devices 110A (e.g., high-volume speakers, alarms, sirens, and/or the like; also denoted “interior-audible device” hereinafter) deployed inside the building 102, one or more audible devices 110B (also denoted “exterior-audible device” hereinafter) deployed outside the building 102 (preferably at a high elevation), one or more visible devices 110C (also denoted “exterior-visible device” hereinafter) such as one or more lights (e.g., strobe lights, flash lights, beacons, and/or the like) deployed outside the building 102, and/or one or more smoke generators 110D deployed outside the building 102 (e.g., on the roof or adjacent a top of an exterior wall of the building 102).

The action devices 110 may be installed at suitable locations inside and/or outside the building 102. For example, one or more interior-audible devices 110A may be installed in hallway, living room, and/or other suitable room of the building 102; one or more exterior-audible devices 110B and strobe lights 110C may be installed on the exterior side (e.g., the front side) of the building 102 adjacent the street at locations of sufficient heights; one or more smoke generators 110D may be installed on the roof or adjacent a top of an exterior wall of the building 102. As will be described in more detail later, the exterior-audible devices 110B and exterior-visible devices 110C and 110D broadcast security/emergency alerts to the nearby public around the building 102.

In some embodiments, the exterior-audible devices 110B may be used for playing a predefined audio record such as a voice record comprising the location or address information of the building 102 and/or the nature of the emergency event. In some embodiments, the voice record may further comprise a request for witness. In some embodiments, the system 100 (e.g., the control circuitry 112) may store a plurality of voice records indicative of respective types of emergency events such as fire, intrusion, domestic violence, and the like). When an emergency event occurs, the control circuitry 112 determines the type of the emergency event based on received sensor data and then broadcasts a corresponding voice record.

The predefined audio record may also be broadcasted inside the building 102 using the interior-audible devices 110A inside the building. Moreover, the predefined audio record and the light signals from the exterior audible devices 110C may be repeatedly broadcasted to the nearby public until the emergency event is over. The smoke generator 110D may also continuously generate smoke until the smoke-generating material is exhausted or the emergency event is over.

Those skilled in the art will appreciate that the sensors and devices installed outside the building 102 may need necessary protection against the weather (e.g., sealing means for protecting the devices against rain).

In some embodiments, the action devices 110 may also comprise an emergency phone line for calling one or more response teams such as the police and/or firefighters (e.g., for calling 911).

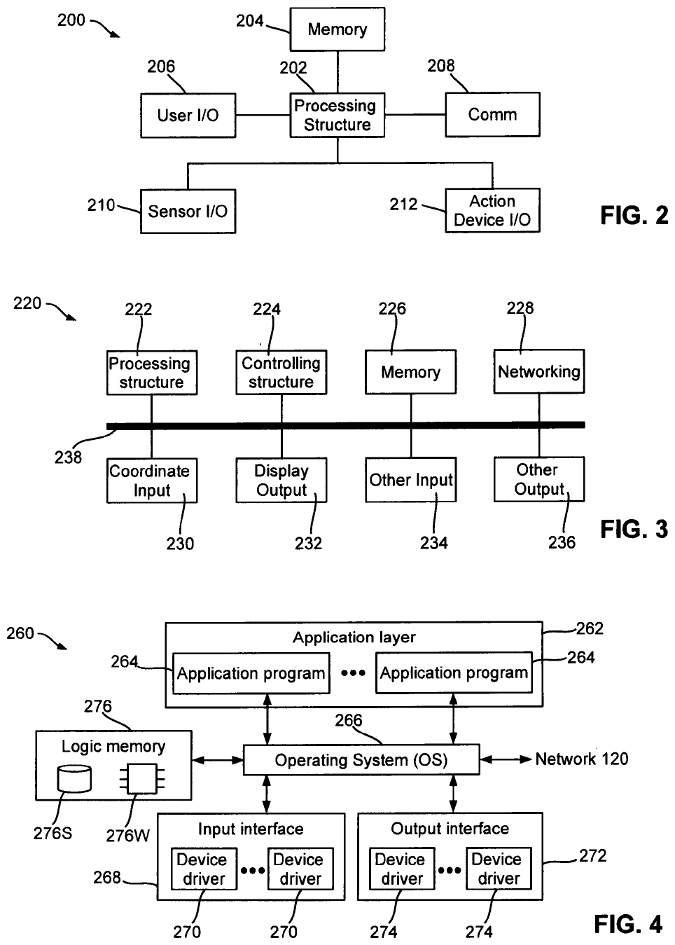

The control circuitry 112 comprises one or more suitable circuits and electrical and/or optical components. FIG. 2 is a block diagram 200 showing the hardware structure of the control circuitry 112.

As shown, the control circuitry 112 comprises a processing structure 202 connected to a memory 204, a user input/output interface 206, a communication interface 208, a sensor input/output interface 210, and an action device input/output interface 212.

The processing structure 202 may be one or more integrated circuit (IC) chips (such as one or more field-programmable gate array (FPGA) chips, one or more application-specific integrated circuit (ASIC) chips, and/or the like), a circuitry having one or more processing structures (e.g., one or more general-purpose processors, one or more real-time processors, one or more customized processors, and/or the like), and/or the like.

The memory 204 may be volatile and/or non-volatile, non-removable or removable memory or storage components such as RAM, ROM, EEPROM, solid-state memory, hard disks, flash memory, and/or the like, storing instructions executable by the processing structure 202 for performing necessary actions such as receiving data from the sensors 108, analyzing received sensor data, and instructing the action devices 110 to perform necessary actions as needed. The memory 204 may also store data received from the sensors, data generated during operation of the processing structure 202, and data to be sent to the action devices 110.

The user input/output interface 206 may be a touchscreen for displaying information to the user and for receiving user inputs. Of course, those skilled in the art will appreciate that other user input/output technologies such as a non-touch-sensitive display and a physical keyboard may alternatively be used.

The communication interface 208 comprises suitable components and circuits for communicating with other devices using suitable wired and/or wireless communication technologies as described above. The memory 204 may also store a set of instructions (so-called “drivers”) for the processing structure 202 to communicate with other devices via the communication interface 208.

The sensor input/output interface 210 comprises suitable components and circuits for connecting with the plurality of sensors 108. The memory 204 may also store a set of instructions (so-called “driver”) for the processing structure 202 to communicate with each sensor 108. In some embodiments, the sensor input/output interface 208 may use the communication interface 208 for communicating with the plurality of sensors 108.

The action device input/output interface 212 comprises suitable components and circuits for connecting with the plurality of action devices 110. The memory 204 may also store a set of instructions or a driver for the processing structure 202 to communicate with the action devices 110. In some embodiments, the action device input/output interface 212 may use the communication interface 208 for communicating with the plurality of action devices 110.

In some embodiments, the control circuitry 112 may be a system on chip (SoC) and comprises an IC chip having all components 202 to 212 shown in FIG. 2.

The server computer 122 executes one or more server programs. Depending on implementation, the server computer 122 may be a server-computing device, and/or a general-purpose computing device acting as a server computer while also being used by a user.

Each client computing device 124 executes one or more client application programs (or so-called “apps”) and for users to use. The client computing devices 124 may be portable computing devices such as laptop computers, tablets, smartphones, Personal Digital Assistants (PDAs) and the like. However, those skilled in the art will appreciate that one or more client computing devices 124 may also be non-portable computing devices such as desktop computers.

Generally, the computing devices 122 and 124 have a similar hardware structure such as a hardware structure 220 shown in FIG. 3. As shown, the computing device 122/124 comprises a processing structure 222, a controlling structure 224, one or more non-transitory computer-readable memory or storage devices 226, a networking interface 228, coordinate input 230, display output 232, and other input and output modules 234 and 236, all functionally interconnected by a system bus 238.

The processing structure 222 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 224 comprises one or more controlling circuits, such as graphic controllers, input/output chipsets and the like, for coordinating operations of various hardware components and modules of the computing device 122/124.

The memory 226 comprises a plurality of memory units accessible by the processing structure 222 and the controlling structure 224 for reading and/or storing instructions for the processing structure 222 to execute, and for reading and/or storing data, including input data and data generated by the processing structure 222 and the controlling structure 224. The memory 226 may be volatile and/or non-volatile, non-removable or removable memory such as RAM, ROM, EEPROM, solid-state memory, hard disks, CD, DVD, flash memory, or the like. In use, the memory 226 is generally divided to a plurality of portions for different use purposes. For example, a portion of the memory 226 (denoted as storage memory herein) may be used for long-term data storing, for example, for storing files or databases. Another portion of the memory 226 may be used as the system memory for storing data during processing (denoted as working memory herein).

The networking interface 228 comprises one or more networking modules for connecting to other computing devices or networks through the network 120 by using suitable wired or wireless communication technologies described above.

The display output 232 comprises one or more display modules for displaying images, such as monitors, LCD displays, LED displays, projectors, and the like. The display output 232 may be a physically integrated part of the computing device 122/124 (for example, the display of a laptop computer or tablet), or may be a display device physically separate from but functionally coupled to other components of the computing device 122/124 (for example, the monitor of a desktop computer).

The coordinate input 230 comprises one or more input modules for one or more users to input coordinate data, such as touch-sensitive screen, touch-sensitive whiteboard, trackball, computer mouse, touch-pad, or other human interface devices (HID) and the like. The coordinate input 230 may be a physically integrated part of the computing device 122/124 (for example, the touch-pad of a laptop computer or the touch-sensitive screen of a tablet), or may be a device physically separate from, but functionally coupled to, other components of the computing device 122/124 (for example, a computer mouse). The coordinate input 230, in some implementation, may be integrated with the display output 232 to form a touch-sensitive screen or touch-sensitive whiteboard.

The computing device 122/124 may also comprise other input 234 such as keyboards, microphones, scanners, cameras, Global Positioning System (GPS) component, and/or the like. The computing device 122/124 may further comprise other output 236 such as speakers, printers and/or the like.

The system bus 238 interconnects various components 222 to 236 enabling them to transmit and receive data and control signals to and from each other.

FIG. 4 shows a simplified software architecture 260 of the computing device 122 or 124. The software architecture 260 comprises an application layer 262, an operating system 266, an input interface 268, an output interface 272, and a logic memory 276. The application layer 262, operating system 266, input interface 268, and output interface 272 are generally implemented as computer-executable instructions or code in the form of software code or firmware code stored in the logic memory 276 which may be executed by the processing structure 222.

The application layer 262 comprises one or more application programs 264 executed by or run by the processing structure 222 for performing various tasks. The operating system 266 manages various hardware components of the computing device 122 or 124 via the input interface 268 and the output interface 272, manages the logic memory 276, and manages and supports the application programs 264. The operating system 266 is also in communication with other computing devices (not shown) via the network 120 to allow application programs 264 to communicate with those running on other computing devices. As those skilled in the art will appreciate, the operating system 266 may be any suitable operating system such as MICROSOFT® WINDOWS® (MICROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDROID is a registered trademark of Google Inc., Mountain View, Calif., USA), or the like. The computing devices 122 and 124 of the security system 100 may all have the same operating system, or may have different operating systems.

The input interface 268 comprises one or more input device drivers 270 for communicating with respective input devices including the coordinate input 230. The output interface 272 comprises one or more output device drivers 274 managed by the operating system 266 for communicating with respective output devices including the display output 232. Input data received from the input devices via the input interface 268 is sent to the application layer 262, and is processed by one or more application programs 264. The output generated by the application programs 264 is sent to respective output devices via the output interface 272.

The logical memory 276 is a logical mapping of the physical memory 226 for facilitating the application programs 264 to access. In this embodiment, the logical memory 276 comprises a storage memory area (276S) that may be mapped to a non-volatile physical memory such as hard disks, solid-state disks, flash drives, and the like, generally for long-term data storage therein. The logical memory 276 also comprises a working memory area (276W) that is generally mapped to high-speed, and in some implementations volatile, physical memory such as RAM, generally for application programs 264 to temporarily store data during program execution. For example, an application program 264 may load data from the storage memory area 276S into the working memory area 276W, and may store data generated during its execution into the working memory area 276W. The application program 264 may also store some data into the storage memory area 276S as required or in response to a user's command.

In a server computer 122, the application layer 262 generally comprises one or more server-side application programs 264 which provide server functions for managing network communication with client computing devices 124 and facilitating collaboration between the server computer 122 and the client computing devices 124. Herein, the term “server” may refer to a server computer 122 from a hardware point of view or a logical server from a software point of view, depending on the context.

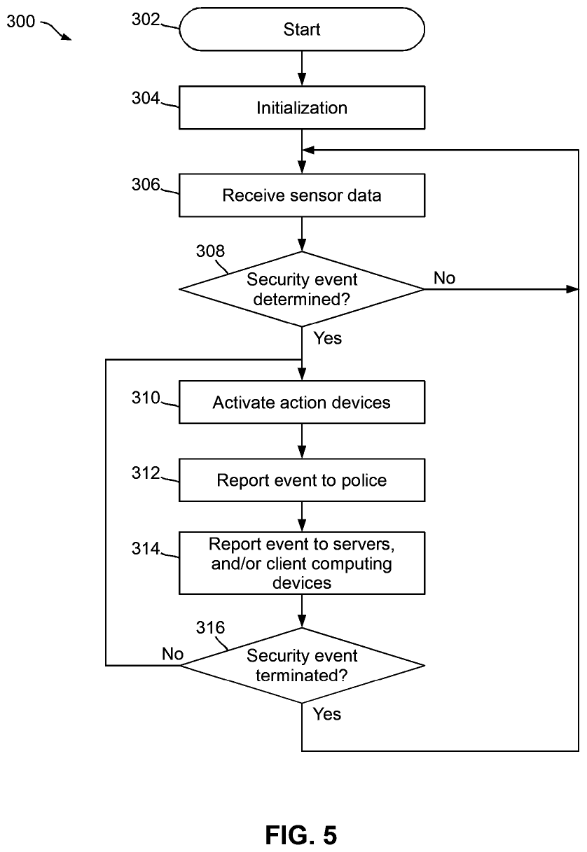

FIG. 5 is a flowchart showing a process 300 executed by the control circuitry 112 for monitoring and responding to emergency events.

The process 300 starts (step 302) after the system 100 is installed to the building 102 and powered on. At step 304, the control circuitry 112 instructs the sensors 108 and action devices 110 to perform an initialization process for reporting errors (if any) and transiting into their operation states.

At step 306, the control circuitry 112 receives data from the sensors 108 and uses received data for detecting emergency events. If no emergency event is detected (the “No” branch of step 308), the process 300 loops back to step 306 to further receive sensor data.

In some embodiments, the detection of an emergency event may be directly based on the data received from one or more sensors 108. For example, an “intrusion” emergency event may be detected if a glass-break sensor 108B detects breaking of glass of a window 106. As another example, the system 100 may be configured to an “armed-at home” state which allows detection of human and/or movement inside the building 102 but would trigger an “intrusion” emergency event if a door 104 or a window 106 is turned open. As a further example, the system 100 may be configured to an “armed-away” state in which an “intrusion” emergency event is determined if a person or a movement inside the building 102 is detected.

In some other embodiments, the detection of an emergency event may be based on an analysis of the data received from one or more sensors 108 using Artificial Intelligence (AI). For example, the control circuitry 112 and/or the server computer 122 may use face-recognition and a machine-learning algorithm to check the identity of a person entering the building 102 and the behavior thereof for determining if the person is an intruder.

Referring back to FIG. 5, if at step 308, one or more emergency events are detected (the “Yes” branch thereof), the control circuitry 112 may immediately activate the action devices 110 to broadcast alerts to people in the building 102 and to the public near the building 102.

In some alternative embodiments, the control circuitry 112 may activate the action devices 110 after a predefined delay. In some alternative embodiments, the control circuitry 112 may activate the action devices 110 after a predefined delay, and may broadcast a verbal countdown (e.g., a 10-second countdown) inside the building 102 before the predefined delay is over.

At step 312, the control circuitry 112 may report the emergency events to the police by calling the emergency phone line (e.g., 911), communicating with a computing device of the police via the network 120, and/or the like.

At step 314, the control circuitry 112 may also report the emergency events to the server computer 122 and/or the client computing devices 124.

At step 316, the control circuitry 112 checks if the emergency events are terminated (e.g., after receiving an event-termination instruction from the server computer 122, after an analysis showing the events are over, after a user in the building 102 manually inputting an event-termination instruction via the touchscreen of the control circuitry 112, and/or the like). If the emergency events are not all terminated (the “No” branch of step 316), the process 300 loops back to step 310 to maintain the activation of the action devices 110. If it is determined that the emergency events are all terminated (the “Yes” branch of step 316), the process 300 loops back to step 306 to further receive sensor data.

In some embodiments, the illumination lights inside and/or outside the building 102 may be used as visible devices. When one or more emergency events are detected, the control circuitry 112 turns on the illumination lights inside the building 102 and controls the illumination lights outside the building 102 to flash with a predefined pattern.

In some embodiments, the security system 100 comprises specialized exterior-visible lights and illumination lights (e.g., high-power illumination lights) deployed outside the building 102. The illumination lights may be deployed around the building 102, or about the entrances thereof.

In an emergency event, the exterior-visible lights are activated to flash with a predefined pattern for broadcasting an alert to the nearby public and the illumination lights are activated to illuminate the exterior of the building 102 for various purposes such as providing illumination to helps that may come, providing illumination to surveillance cameras around the building 102, deterring the intruder, and/or the like.

In some embodiments, by using the system 100 and the process 300, when one or more emergency events are detected, at least some of the following action devices 110 are activated:

Illumination lights inside the building 102 are turned on for providing users in the building 102 necessary illumination and for warning the intruder (in an security event);

Interior-audible devices 110A inside the building 102 are activated for providing users in the building 102 necessary announcement and/or instructions and for warning the intruder (in an security event);

Exterior-audible devices 110B outside the building 102 are activated for providing the nearby public an alert (as described above, the alert may comprise location information of the building 102);

Exterior-visible lights 110C outside the building 102 are activated for providing the nearby public an alert; and

Smoke generators 110D outside the building 102 are activated for generating an exterior-visible smoke with a predefined color (e.g., a red color) for providing the public at a distance an alert; the smoke may also facilitate relevant people (e.g., police, firefighters, emergency health teams, and/or the like) to locate the building 102.

In some embodiments wherein the building 102 may be a public-accessible building (e.g., a building in a school or in a shopping center), the action devices 110 may also comprise one or more identification-mark spray devices connected to the control circuitry 112 using suitable connections such as RS-485 cables for spraying a suitable identification-mark such as a detectable material (e.g., a detectable ink or detectable powder) which, when in contact with fabric or skin, may be difficult to remove. The one or more identification-mark spray devices may be deployed in the hallways and/or adjacent the entrances of the building 102 such as doors 104 and/or windows 106 at suitable elevations, e.g., about an average person's leg or body.

In some embodiments, the detectable material may have a visible color. In some other embodiments, the detectable material may have an invisible “color” which is generally invisible to bare human eyes but is a detectable by an imaging device with a suitable optical filter. In yet some other embodiments, the detectable material may have another suitable detectable characteristic such as a magnetic or ferromagnetic ink or powder. Herein, the term “magnetic” refers to a material having a magnetic field and the term “ferromagnetic” refers to a material without magnetic field but may be detectable in a magnetic field.

In some embodiments, the system 100 allows a user thereof to remotely trigger an emergency event from their client computing device, e.g., when the user observes from one or more sensors 108 (e.g., a surveillance camera of the system 100) that an emergency event is occurring.

In some embodiments wherein the building 102 may be a public-accessible building (e.g., a building in a school or in a shopping center), the action devices 110 may further comprise one or more suitable capturing devices such as one or more net guns deployed in the hallways and/or adjacent the entrances of the building 102 such as doors 104 and/or windows 106 and connected to the control circuitry 112 using suitable connections such as RS-485 cables for ejecting a net to capture the intruder.

In some embodiments, the building 102 may be a multiple-unit building such as a condominium building or an office building having a plurality of building units or suites. In these embodiments, a plurality of sensors 108 and some action devices 110 may be deployed in each of one or more building units and public areas (such as hallways, main entrance, reception, and the like) as needed and in a similar manner as described above. One or more interior-audible devices 110A may also be deployed in the public areas of the building 102.

In some of these embodiments, each building unit may comprise a control circuitry 112 and the building 102 may further comprise a central control circuitry or a computing device connecting to the control circuitries 112 in the building units and acting as a central control. In some others of these embodiments, the building units do not comprise any control circuitry 112. Rather, the building 102 comprises a central control circuitry directing connecting to the sensors 108 and action devices 110.

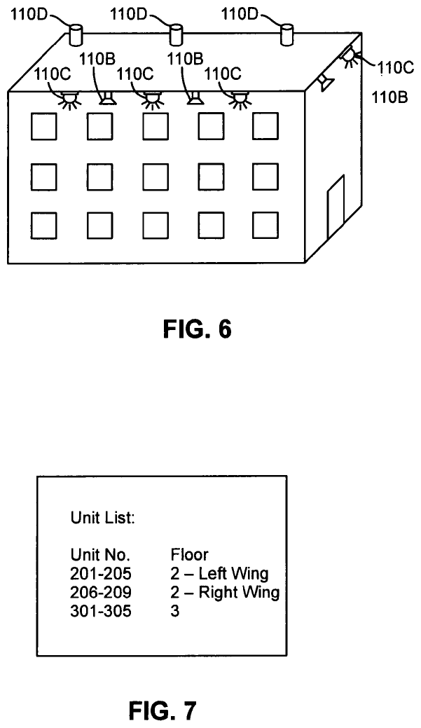

As shown in FIG. 6, some action devices 110, such as exterior-audible devices 110B and exterior-visible lights 110C may be deployed outside the building 102. Moreover, one or more smoke generators 110D may be deployed on the roof or adjacent a top of an exterior wall of the building 102. For example, in some embodiments wherein the building 102 comprises a plurality of sections each having an entrance, a smoke generator 110D may be deployed at a location corresponding to each section for indicating an approximate location of the entrance thereof.

In these embodiments, an information display may also be deployed at the main entrances and/or the reception of the building 102 and connecting to the central control circuitry for showing a list of building units and the floors thereon. When an emergency event occurs, the information display may further show an alarm or warning sign for indicating the floor and/or building unit experiencing the emergency event. FIG. 7 shows an example of the building unit list shown on the information display.

In some embodiments with high privacy protection requirements, the information display may only show the floors of the building 102 without listing the building units thereof.

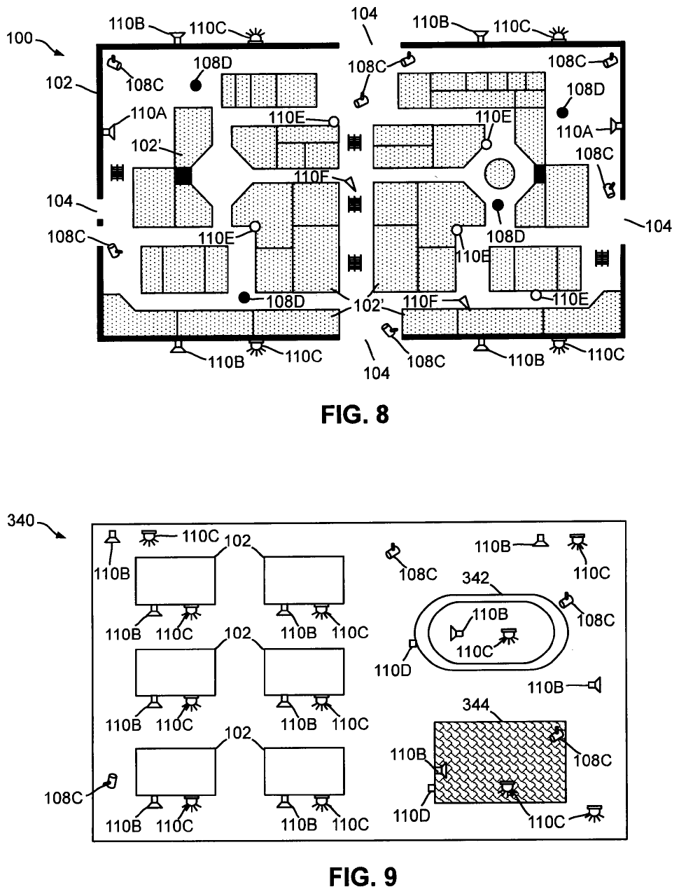

FIG. 8 show an example of the security system 100. In this example, the security system 100 is deployed in a shopping mall 102 having a plurality of entrances 104. The windows of the shopping mall 102 are omitted in FIG. 8 for simplicity. The shopping mall 102 comprises a plurality of counters 102′.

The security system 100 in this example comprises a plurality of sensors 108 such as a plurality of surveillance cameras 108C deployed at suitable locations of the shopping mall 102 including the entrances 104, and a plurality of smoke detectors 108D.

The security system 100 in this example also comprises a plurality of action devices 110 such as a plurality of interior-audible devices 110A, a plurality of exterior-audible devices 110B, a plurality of exterior-visible lights 110C, one or more smoke generators (not shown) on the roof of the shopping mall 102, a plurality of identification-mark spray devices 110D and net guns 110E at key locations of the paths in the shopping mall 102. The sensors 108 and action devices 110 are connected to a control circuitry 112 (not shown).

As described above, the control circuitry 112 receives data from the sensors 108 for detection emergency events, and when an emergency event is detected, activates the action devices 110 to broadcast alerts, monitor the position of the intruder (if the emergency event is an intrusion event), sprays the identification mark when the intruder is adjacent an identification-mark spray device 110D, and/or eject a net from a net gun 110E to capture the intruder when the intruder is in proximity with the net gun 110E.

In some embodiments, each building unit is equipped with an identification-mark spray device for spraying a suitable identification-mark to intruders. The public areas of the building 102 are equipped with corresponding identification-mark detection devices connected to the central control circuitry for detecting the marked intruders. The central control circuitry receives detection data from the identification-mark detection devices, determines the location of the intruder based on the received detection data, and sends the location information to suitable users such as building manager, police, and/or the public.

In some embodiments wherein the building 102 and/or the building units thereof comprise their own audio devices, such audio devices may be connected to the control circuitry 112 in the respective building units and/or the central control circuitry of the building 102 and used as the interior-audible devices 110A.

In some embodiments, the system 100 may be deployed in schools. In these embodiments, classrooms, offices, and public areas may each comprise a set of sensors 108 and action devices 110. Optionally, the existing broadcasting system of the school may be used as interior-audible devices 110A and/or exterior-audible devices 110B with additional exterior-audible devices 110B deployed about the boundary of the school for broadcasting alerts to the public.

In these embodiments, the net guns may be deployed in relatively narrow spaces such as hallways to ensure the successful capture of intruders. The identification-mark spray devices may be deployed in relatively closed spaces to ensure that the sprayed ink or powder may effectively cover the space. Existing surveillance cameras may be used with suitable filters to act as identification-mark detection devices. Moreover, the system 100 may also be connected with any existing surveillance/security systems already deployed in the school.

FIG. 9 show an example of the security system 100 deployed in a school 340. In this example, the school 340 comprise a plurality of buildings 102 and other facilities such as a running track 342 and a playground 344.

In this example, each building 102 is deployed with a plurality of sensors (not shown) and action devices 110 as described above. Moreover, the security system 100 in this example also comprises a plurality of sensors such as surveillance cameras 108C and a plurality of action devices 110 (e.g., exterior-audible and exterior-visible devices 110B, 110C, and 110D) deployed in the outdoor areas of the school 340 such as in and/or about the running track 342 and the playground 344. All sensors 108 and action devices 110 are connected to a control circuitry (not shown).

As described above, the control circuitry receives data from the sensors 108 for detection emergency events, and when an emergency event is detected, activates the action devices 110 to broadcast alerts and monitor the position of the intruder (if the emergency event is an intrusion event).

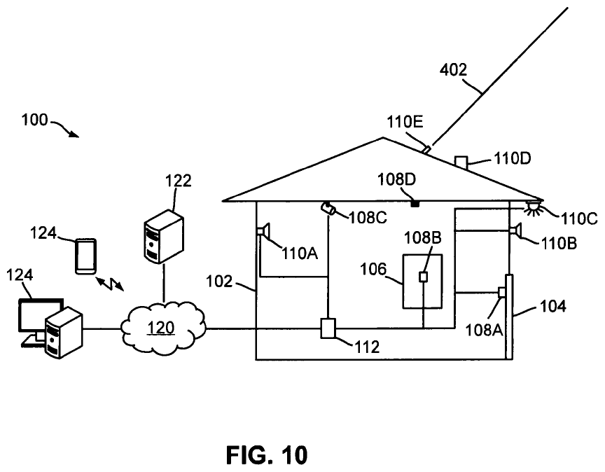

In some embodiments as shown in FIG. 10, the exterior-visible devices 110 of the security system 100 may further comprise one or more light-beam devices 110E such as high-power beam lights, laser pointers, and/or the like, deployed outside the building 102 (e.g., on the roof thereof). The one or more light-beam devices are connected to the control circuitry 112 and may be activated by the control circuitry 112 for emitting a light beam 402 generally towards the sky during for indication of an emergency event and the location of the building 102.

In some embodiments, the light beam 402 emitted from the light-beam devices 110E may flash with a predefined pattern. In some embodiments, the predefined flashing pattern of the light beam 402 may represent a coded message such as a “SOS” message encoded using the Morse code or other suitable code.

In some embodiments, the control circuitry 112 may only activate the light-beam devices 110E when an emergency event occurs at night or in a dark environment determined by a light sensor.

In various embodiments, the security system 100 disclosed herein provides flexible configurations for monitoring a building, detecting emergency events occurred therein, and providing alerts to people therein and to the public nearby, thereby deterring intruders, facilitating emergency responses, and increasing witnesses and the reliability of their observations. The security system 100 disclosed herein provides employs various action devices such as publically audible devices (e.g., exterior-audible devices 110B) and publically visible devices (e.g., exterior-visible lights 110C and exterior-visible smoke generator 110D) which may be used alone or in various combination, for providing public alerts.

For example, in case of a domestic violence occurs in a residential building 102, the victim may press an emergency button in the building 102 to trigger the broadcasting of an emergency event to the nearby public and to the police. Consequently, helps from nearby public and the police may come quickly to the victim.

In various embodiments, the security system 100 disclosed herein may also provide event notifications to users and relevant response teams such as police, fire-fighters, emergency health teams via suitable communication technologies (e.g., via phone calls or client computing devices connected to the network 120) with updates of the events including, e.g., the location of intruders.

Although embodiments have been described above with reference to the accompanying drawings, those of skill in the art will appreciate that variations and modifications may be made without departing from the scope thereof as defined by the appended claims.

What is claimed is:

1. A security system for detecting an emergency event in a building, the system comprising:
one or more sensors deployed in the building for monitoring the building;
one or more first action devices deployed in the building for responding to the emergency event;
one or more second action devices deployed outside the building for broadcasting an alert of the emergency event to public near the building; and
a control circuitry connected to the one or more sensors, the one or more first action devices, and the one or more second action devices for collecting data from the one or more sensors, detecting the emergency event, and responding to the emergency event with broadcasting the alert of the emergency event to the public near the building;
wherein the one or more second action devices comprise:
one or more smoke generators deployed outside the building on a roof thereof for generating exterior-visible, colored smoke for broadcasting the alert of the emergency event to the public near the building; and
one or more audible devices for broadcasting an audible alert during the emergency event, said audible alert comprising information of a location of the emergency event.

2. The security system of claim 1, wherein the building comprises a plurality of entrances; and
wherein each of the one or more smoke generators is deployed outside the building on the roof thereof at one or more locations corresponding to one or more entrances of the building.

3. The security system of claim 1 or 2, wherein the one or more second action devices further comprise:
one or more lights for flashing with a predefined pattern during the emergency event.

4. The security system of any one of claims 1 to 3 further comprising:
one or more server computers connected to the control circuitry via a network.

5. The security system of claim 4 further comprising:
one or more client computing devices connected to the control circuitry via a network.

6. The security system of any one of claims 1 to 5 further comprising:
one or more identification-mark spray devices connected to the control circuitry for spraying an identification-mark.

7. The security system of claim 6, wherein the identification-mark comprises a detectable material attachable to an intruder.

8. The security system of claim 7, wherein the identification-mark comprise a colored ink and/or a colored powder attachable to the intruder.

9. The security system of claim 7, wherein the identification-mark comprise a magnetic or ferromagnetic ink or powder attachable to the intruder.

10. The security system of any one of claims 7 to 9, wherein the one or more identification-mark spray devices are at one or more entrances of the building aiming towards a predefined body section of the intruder.

11. The security system of any one of claims 1 to 10 further comprising:
one or more net guns.

12. The security system of any one of claims 1 to 11, wherein the building comprises a plurality of building units; and the security system further comprising:
a display for showing a list of the building units and/or floors thereof and, during the emergency event, for showing an indication of one of the building units and/or one of the floors where the emergency event is occurring.

13. The security system of any one of claims 1 to 12 further comprising:
a connection to one or more response teams.

14. One or more non-transitory computer-readable storage devices comprising computer-executable instructions for detecting an emergency event in a building, wherein the instructions, when executed, cause a processing structure to perform actions comprising:
receiving data from a plurality of sensors deployed in the building;
detecting the emergency event;
activating one or more first action devices deployed in the building for responding to the emergency event; and
broadcasting the emergency event to public near the building;
wherein said broadcasting the emergency event to the public near the building comprises:
broadcasting the emergency event to the public near the building via one or more smoke generators deployed outside the building on a roof thereof, wherein the one or more smoke generators generate exterior-visible, colored smoke; and
broadcasting the emergency event to the public near the building by broadcasting an audible alert via one or more audible devices deployed outside the building, said audible alert comprising information of a location of the emergency event.

15. The one or more non-transitory computer-readable storage devices according to claim 14, wherein said broadcasting the emergency event to the public near the building comprises:
broadcasting the emergency event to the public near the building via one or more smoke generators deployed outside the building on the roof thereof at one or more locations corresponding to one or more of entrances.

16. The one or more non-transitory computer-readable storage devices according to claim 14 or 15, wherein said broadcasting the emergency event to the public near the building comprises:
broadcasting the emergency event to the public near the building via one or more lights deployed outside the building and flashing with a predefined pattern.

17. The one or more non-transitory computer-readable storage devices according to any one of claims 14 to 16, wherein the instructions, when executed, cause the processing structure to perform further actions comprising:
sending information of the emergency event to a server computer via a network.

18. The one or more non-transitory computer-readable storage devices according to claim 17, wherein the instructions, when executed, cause the processing structure to perform further actions comprising:
sending information of the emergency event to one or more client computing devices via the network.

19. The one or more non-transitory computer-readable storage devices according to any one of claims 14 to 18, wherein the instructions, when executed, cause the processing structure to perform further actions comprising:
detecting an intruder.

20. The one or more non-transitory computer-readable storage devices according to claim 19, wherein the instructions, when executed, cause the processing structure to perform further actions comprising:
spraying an identification-mark about the intruder.

21. The one or more non-transitory computer-readable storage devices according to claim 19, wherein the instructions, when executed, cause the processing structure to perform further actions comprising:
spraying a colored ink and/or a colored powder about the intruder.

22. The one or more non-transitory computer-readable storage devices according to claim 19, wherein the instructions, when executed, cause the processing structure to perform further actions comprising:
spraying a magnetic or ferromagnetic ink or powder about the intruder.

23. The one or more non-transitory computer-readable storage devices according to any one of claims 19 to 22, wherein the instructions, when executed, cause the processing structure to perform further actions comprising:
ejecting a net towards the intruder.

24. The one or more non-transitory computer-readable storage devices according to any one of claims 14 to 23, wherein the building comprises a plurality of building units; and wherein the instructions, when executed, cause the processing structure to perform further actions comprising:
displaying a list of the building units and/or floors thereof; and
displaying, during the emergency event, an indication of one of the building units and/or one of the floors where the emergency event is occurring.

25. The one or more non-transitory computer-readable storage devices according to any one of claims 14 to 24, wherein the building comprises a plurality of building units; and wherein the instructions, when executed, cause the processing structure to perform further actions comprising:
reporting the emergency event to one or more response teams.
